(19) United States
(12) Patent Application Publication
(10) Pub. No.: US 2026/0225648 A1
(43) Pub. Date: Aug. 6, 2026

(54) REAR WHEEL STEERING CONTROL APPARATUS OF VEHICLE AND METHOD THEREFOR

(71) Applicant: HYUNDAI MOBIS CO., LTD., Seoul (KR)

(72) Inventors: Kyoung Wook MIN, Yongin-si (KR); Kyoung Soo LIM, Yongin-si (KR); Han Wul KIM, Yongin-si (KR)

(73) Assignee: HYUNDAI MOBIS CO., LTD., Seoul (KR)

(21) Appl. No.: 19/348,900

(22) Filed: Oct. 3, 2025

(30) Foreign Application Priority Data
Feb. 4, 2025 (KR) 10-2025-0014105

(51) Int. Cl. B62D 6/00; B62D 5/04

(52) U.S. Cl. CPC B62D 6/003; B62D 5/046; B62D 5/0481

(57) ABSTRACT

A rear wheel steering control apparatus of a vehicle includes an input module that receives state information of the vehicle, a rear wheel steering drive module that drives a drive motor according to a rear wheel steering angle to steer rear wheels of the vehicle, a motor position sensor that measures a motor angle of the drive motor, and a processor that is operatively coupled to the input module, the rear wheel steering drive module, and the motor position sensor. The processor drives the rear wheel steering drive module based on the rear wheel steering angle and the motor angle and determines whether the vehicle is in a straight driving state to output occurrence of a belt jump through an output module.

### CROSS-REFERENCE TO RELATED APPLICATION

This application claims the benefit under 35 U.S.C. §119(a) of priority to Korean Patent Application No. 10-2025-0014105 filed on February 4, 2025, in the Korean Intellectual Property Office, the entire disclosure of which is incorporated herein by reference for all purposes.

### BACKGROUND

### Technical Field

The present disclosure relates to a rear wheel steering control apparatus of a vehicle and a method therefore, and more particularly, to a rear wheel steering control apparatus of a vehicle and a method therefore, which can detect a belt jump and set an absolute angle zero point(or absolute angle zero position) of a motor angle based on a motor position sensor without including a linear sensor in a rear wheel steering system.

### Related Art

A steering system of a vehicle controls the position or direction of the vehicle as desired by a driver. Generally, a hydraulic power steering apparatus is used that obtains hydraulic assistance through a pump connected to a crankshaft of an engine to reduce the driver's operating force on the steering wheels.

However, such a hydraulic power steering apparatus has the disadvantage in that the hydraulic power steering apparatus is dependent on the rotation speed of the engine because the hydraulic power steering apparatus obtains the hydraulic assistance by a pump connected to the crankshaft of the engine and uses the engine output, thereby reducing the engine output.

When the vehicle is stopped or at a low speed, the engine speed is low despite the large vehicle load applied to the vehicle tires, which lowers the hydraulic assist of the pump. On the other hand, when the vehicle is at a high speed, the engine speed is high despite the relatively small vehicle load applied to the vehicle tires, so the hydraulic assistance of the pump becomes high. As a result, there are contradictory problems depending on the condition of the vehicle, that is, large steering force is required when stopping or at low speeds and relatively little steering force is required at high speeds.

In addition, it is difficult to obtain the desired steering due to changes in variables that determine steering due to road conditions and other external factors.

Recently, a motor driven power steering (MDPS) apparatus is applied, in which a motor driven actuator is installed in the steering system of a vehicle and turns the front wheels of the vehicle left and right as the driver turns the steering wheel, thereby steering the driving direction of the vehicle.

The motor driven power steering (MDPS) apparatuses are equipped with a torque sensor that measures the driver's steering torque input to the steering wheel, a steering angle sensor that measures the steering angle of the steering wheel, and a vehicle speed sensor that measures the vehicle speed, and determine the driving conditions of the vehicle to control the current supplied to a drive actuator such as a motor to steer.

Meanwhile, a four-wheel steering system has recently been developed that can operate the front and rear wheels simultaneously by operating the steering wheel. The four-wheel steering system transmits lateral force to the front and rear wheels simultaneously to stabilize the behavior of the vehicle by steering the rear wheels of the vehicle in phase when changing lanes while driving at high speeds. In addition, the four-wheel steering system independently steers the four wheels to relatively reduce a turning radius of the vehicle by steering the rear wheels in reverse phase at low vehicle speeds, when parking, or when making a U-turn, thereby increasing convenience and efficiency in narrow spaces such as narrow roads and canyons.

The background technology of the present disclosure is disclosed in Korean Patent Registration No. 10-0518347 (registered on September 29, 2005, entitled "Intelligent four-wheel steering system").

The above-described information disclosed in the background technology of the present disclosure is only intended to improve understanding of the background of the present disclosure and therefore may include information that does not constitute prior art.

### SUMMARY

In this way, the rear wheel steering system can be applied independently along with the motor driven steering apparatus for four-wheel steering.

The rear wheel steering (RWS) system receives the steering angle and vehicle speed of a steering wheel to determine a rear wheel angle and drives an RWS actuator to control the rear wheel angle, thereby providing rear wheel steering responsiveness and driving stability.

The rear-wheel steering system steers the rear wheels in the opposite direction to the front wheels (i.e., steers the rear wheels in the opposite direction to the front wheels) to reduce the turning radius, thereby improving rear-wheel steering response when the vehicle is traveling at low speeds, and steers the rear wheels in the same direction as the front wheels (i.e., steers the rear wheels in the same direction as the front wheels) to reduce the yaw rate, thereby providing driving stability when the vehicle is traveling at high speeds.

In this way, in order to control the rear wheel steering, signals such as the steering angle and vehicle speed are input to calculate the rear wheel steering angle, and the rear wheel steering is controlled according to the calculated rear wheel steering angle.

That is, by operating the drive motor connected to the drive wheel according to the rear wheel steering angle, the vehicle can be steered by providing displacement to the rack bar connected to the wheel.

In this way, displacement is generated in a rack bar by the meshing of a pinion gear rotated by the drive motor and a rack gear installed on the rack bar, and the rear wheel angle can be adjusted by measuring the movement distance of the rack bar.

In this case, not only is the movement distance of the rack bar calculated through a motor position sensor (MPS) that measures the rotation angle of the drive motor, but a linear position sensor (LPS) is installed on the rack bar to measure the movement distance of the rack bar.

In this case, the motor position sensor measures the relative motor angle of the drive motor and the linear position sensor measures the absolute displacement of the rack bar, and both of these are applied to perform the rear wheel steering. In particular, not only is the initial absolute angle zero point position of the rear wheel angle confirmed based on the displacement amount of the linear position sensor, but the belt jump is detected to check the position error.

However, because the wheel rotation angle requirements differ for each automobile manufacturer, not only is the measurement range of the linear position sensor for measuring the movement distance of the rack bar different, but the space for installing the linear position sensor is also increased proportionally when the movement range of the rack bar is wide, resulting in a structure that is disadvantageous to the surrounding packages.

In addition, when steering control is performed by installing only a motor position sensor without a linear position sensor, there is a problem in that belt jumps cannot be detected or the position of the absolute angle zero point cannot be confirmed after a failure or resetting.

The present disclosure is made to improve the above-described problems, and one aspect of the present disclosure provides a rear wheel steering control apparatus and a method therefore, capable of detecting belt jump and setting an absolute angle zero point of a motor angle by collecting a driving state of the vehicle based on a motor position sensor without providing a linear position sensor in a rear wheel steering system.

However, the technical problems to be solved by the present disclosure are not limited to the problems described above, and other problems not mentioned can be clearly understood by those skilled in the art from the description of the disclosure described below.

In an embodiment of the present disclosure, a rear wheel steering control apparatus of a vehicle includes an input module configured to receive state information of the vehicle, a rear wheel steering drive module configured to drive a drive motor according to a rear wheel steering angle to steer rear wheels of the vehicle, a motor position sensor configured to measure a motor angle of the drive motor, and a processor that is operatively coupled to the input module, the rear wheel steering drive module, and the motor position sensor. The processor is configured to drive the rear wheel steering drive module based on the rear wheel steering angle and the motor angle, and to determine whether the vehicle is in a straight driving state to output occurrence of a belt jump through an output module.

The processor may be configured to determine that the vehicle is in the straight driving state when both lateral acceleration and yaw rate of the vehicle are within a set range in a straight steering state.

The processor may be configured to determine the vehicle is in the straight driving state in the straight steering state to determine that the belt jump occurs when one or both of the lateral acceleration and the yaw rate are out of the set range and to output a warning.

When the belt jump or a reset occurs, the processor may be configured to output a response manual through the output module, to determine that the vehicle is in a creep driving state and in a straight steering state based on vehicle speed and a steering angle, and to set the current motor angle as an absolute angle of zero point based on the straight driving state of the vehicle.

The processor may be configured to determine whether the vehicle is in the straight driving state and to perform slip angle feedback control when the vehicle is not in the straight driving state.

In another embodiment of the present disclosure, a rear wheel steering control method of a vehicle includes driving, by a processor, a rear wheel steering drive module based on a rear wheel steering angle and a motor angle of a drive motor, determining, by the processor, whether the vehicle is in a straight driving state, and outputting, by the processor, a belt jump warning based on a result of determining whether the vehicle is in the straight driving state.

In determining whether the vehicle is in the straight driving state, when both lateral acceleration and yaw rate of the vehicle are within set ranges in a straight steering state, the processor may determine that the vehicle is in the straight driving state.

In outputting the belt jump warning, when one or both of the lateral acceleration and the yaw rate are out of the set ranges as a result of determining whether the vehicle is in the straight driving state, the processor may determine that the belt jump occurs.

The rear wheel steering control method may further include outputting, by the processor, a response manual through an output module when the belt jump occurs or a reset occurs, determining, by the processor, whether the vehicle is in a creep driving state and a straight steering state based on vehicle speed and a steering angle after outputting the response manual, determining, by the processor, whether the vehicle is in the straight driving state after determining whether the vehicle is in the creep driving state and the straight steering state, and setting, by the processor, a current motor angle as an absolute angle of zero point based on a result of determining whether the vehicle is in the straight driving state.

The rear wheel steering control method may further include performing, by the processor, slip angle feedback control when the vehicle is not in the straight driving state as a result of determining whether the vehicle is in the straight driving state.

According to the rear wheel steering control apparatus of a vehicle and the method therefore according to the present disclosure, the driving state of the vehicle is collected based on the motor position sensor without the linear position sensor in the rear-wheel steering system, thereby detecting belt jumps, and even in the event of a failure or resetting, the absolute angle zero point of the motor angle can be set without the linear position sensor, which not only reduces costs but also secures space for installing the linear position sensor, thereby increasing spatial freedom.

However, the effects obtainable through the present disclosure are not limited to the effects described above, and other technical effects not mentioned will be clearly understood by those skilled in the art from the description of the disclosure described below.

### BRIEF DESCRIPTION OF THE DRAWINGS

FIG. 1 is a block diagram illustrating a rear wheel steering control apparatus of a vehicle according to an embodiment of the present disclosure.

FIG. 2 is a diagram illustrating a process of setting an absolute angle of zero point of a rear wheel steering in a rear wheel steering control apparatus of a vehicle according to an embodiment of the present disclosure.

FIG. 3 is a flowchart illustrating a process of warning of a belt jump in a rear wheel steering control method of a vehicle according to an embodiment of the present disclosure.

FIG. 4 is a flowchart illustrating a process of setting an absolute angle in a rear wheel steering control method of a vehicle according to an embodiment of the present disclosure.

### DETAILED DESCRIPTION

Hereinafter, a rear wheel steering control apparatus of a vehicle and a method therefore according to the present disclosure will be described in detail below with reference to the accompanying drawings through various exemplary embodiments.

It should be considered that the thickness of each line or the size of each component in the drawings may be exaggeratedly illustrated for clarity and convenience of description. In addition, terms to be described below have been defined by taking into consideration their functions in the present disclosure, and may be different depending on a user or operator's intention or practice. Accordingly, such terms should be interpreted based on the overall contents of this specification.

Hereinafter, embodiments of the present disclosure will be described in detail with reference to the accompanying drawings so that those skilled in the art may easily implement the present disclosure. However, the present disclosure may be implemented in a number of different forms and is not limited to the embodiments described herein. In order to clearly describe the present disclosure in the drawings, parts irrelevant to the description are omitted, and similar reference numerals are added to similar parts throughout the specification.

Throughout the specification, when a part "includes" a component, this means that it may further include other components, rather than excluding other components unless specifically opposed.

The implementations described herein may be implemented, for example, as a method or process, device, software program, data stream or signal. Even if discussed only in the context of a single form of implementation (e.g., only as a method), the implementation of the discussed features may also be implemented in other forms (e.g., device or program). The device can be implemented with appropriate hardware, software and firmware. The method can be implemented, for example, in devices such as processors that generally refer to processing devices including computers, microprocessors, integrated circuits, or programmable logic devices.

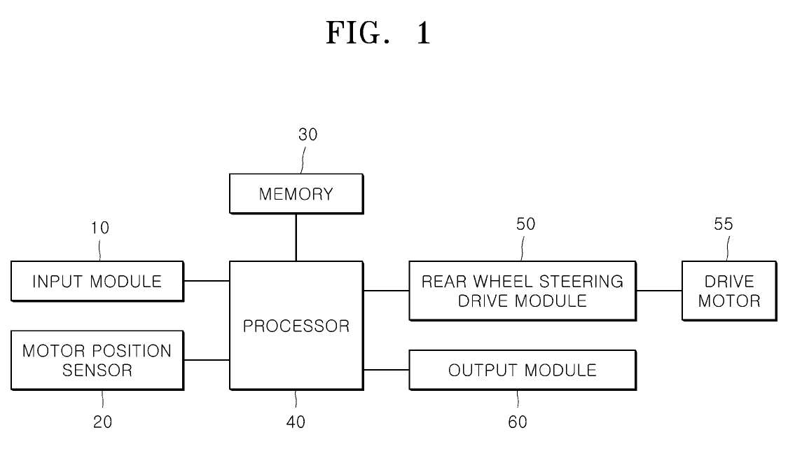

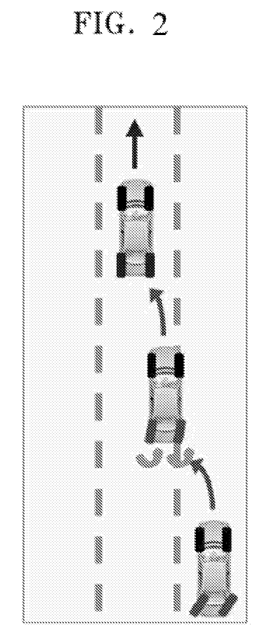

FIG. 1 is a block diagram illustrating a rear wheel steering control apparatus of a vehicle according to an embodiment of the present disclosure. FIG. 2 is a diagram illustrating a process of setting an absolute angle of zero point of rear wheel steering in the rear wheel steering control apparatus of a vehicle according to an embodiment of the present disclosure.

As shown in FIG. 1, the rear wheel steering control apparatus of a vehicle according to an embodiment of the present disclosure includes an input module 10, a motor position sensor 20, a rear wheel steering drive module 50, an output module 60, a memory 30, and a processor 40.

The input module 10 receives state information of the vehicle from an in-vehicle control device through CAN communication. Here, the state information of the vehicle input through the input module 10 may include a steering angle, lateral acceleration, a yaw rate, and vehicle speed.

The rear wheel steering drive module 50 operates a drive motor 55 based on a rear wheel steering angle output from the processor 40 to steer the rear wheels of the vehicle with the driving force of the drive motor 55.

The motor position sensor 20 measures a motor angle according to the rotation of the drive motor 55. In this case, for the motor angle, a relative motor angle may be measured through the rotation direction and rotation amount of the drive motor 55.

The output module 60 is installed on a center fascia of the vehicle to output a detection result of detecting a belt jump and outputs a response manual for setting an absolute angle of zero point.

Here, the content output from the response manual may be to perform creep driving at low speed, align a steering handle to the center to set the steering angle to zero , and maintain straight driving for more than a set time.

The memory 30 stores data related to an execution program for controlling the rear wheel steering control apparatus of a vehicle, and the stored information is independently selected by the processor 40 as needed.

That is, the memory 30 stores various types of data generated during the execution of an operating system or application (program or applet) for driving the rear wheel steering control apparatus of a vehicle. In this case, the memory 30 may be implemented with a nonvolatile storage device that continuously maintains the stored information even when power is not supplied or a volatile storage device that requires power to maintain the stored information. In addition, the memory 30 performs a function of temporarily or permanently storing data processed by the processor 40.

Here, the memory 30 may include a magnetic storage medium or a flash storage medium in addition to the volatile storage device requiring power to maintain the stored information, but the scope of the present disclosure is not limited thereto.

The processor 40 is operatively coupled to the input module 10, the motor position sensor 20, the memory 30, the rear wheel steering drive module 50, and the output module 60 to be implemented as an integrated circuit or system that controls the overall operation of the rear wheel steering control apparatus of a vehicle, and performs various operations by copying various programs stored in the memory device 30 to the RAM and executing the programs.

In various embodiments, the processor 40 may be implemented as a digital signal processor (DSP), a microprocessor, and a time controller (TCON) that processes digital signals. However, the present disclosure is not limited thereto, and the processor 40 may include one or more of a central processing unit (CPU), a micro controller unit (MCU), a micro processing unit (MPU), a controller, an application processor (AP), a communication processor (CP), or an ARM processor, or may be defined by those terms. In addition, the processor 40 may be implemented as a system on chip (SoC) with a built-in processing algorithm, a large scale integration (LSI), or in the form of a field programmable gate array (FPGA).

That is, the processor 40 drives the execution program stored in the memory 30 to receive the steering angle, the lateral acceleration, the yaw rate, and the vehicle speed from the input module 10 and calculates the rear wheel steering angle based on the vehicle speed, the steering angle, the lateral acceleration, and the yaw rate.

In this case, when the vehicle is traveling at low speed, the rear wheel steering control apparatus of a vehicle steers the rear wheels in a direction opposite to a front wheel steering direction (i.e., steers the rear wheels in reverse phase with the front wheels) to reduce a rotation radius, thereby calculating the rear wheel steering angle to improve rear wheel responsiveness. In addition, when the vehicle is traveling at high speed, the rear wheel steering control apparatus of a vehicle steers the rear wheels in the same direction as the front wheels (i.e., steers the rear wheels in the same direction as the front wheels) to reduce the yaw rate, thereby calculating the rear wheel steering angle to provide driving stability.

Based on the calculated rear wheel steering angle and a motor angle measured by the motor position sensor 20, the processor 40 drives the rear wheel steering drive module 50 to steer the rear wheels through the driving force of the drive motor 55.

When traveling by steering the rear wheels in this way, the processor 40 determines whether a belt jump occurs by determining whether the vehicle is in a straight driving state under the straight driving condition of the vehicle, that is, in a center alignment state where the steering angle is zero , and outputs the occurrence of the belt jump through the output module 60.

In this case, the processor 40 may determine whether the vehicle is in the straight driving state based on the steering angle, the lateral acceleration, and the yaw rate input from the input module 10.

For example, when the steering angle is 0±0.1 [deg], the lateral acceleration is 0±0.01 [g], and the yaw rate is 0±0.02 [deg/s], the processor 40 may not only determine that the vehicle is in the straight driving state, but also determine that the driving state is a normal state in which no belt jump occurs.

However, when a belt jump occurs, an error may occur in the motor angle for driving the rear wheels even when the steering angle and rear steering angle are aligned to zero point for straight driving, and thus the vehicle may not drive straight or may experience vibrations, which may cause changes in the lateral acceleration and yaw rate.

Therefore, when either the lateral acceleration or the yaw rate is out of a set range in the straight steering state, the processor 40 determines that it is a belt jump and outputs a warning through the output module 60.

In this way, when a belt jump occurs and a warning is output or a reset occurs, the processor 40 outputs a response manual for setting an absolute angle of zero point through the output module 60.

Thereafter, the processor 40 determines the vehicle is in creep driving and straight steering state based on the vehicle speed and steering angle, and sets the current motor angle as the absolute angle of zero point when the vehicle is in the creep driving state and the straight steering state.

That is, when the vehicle creeps below set vehicle speed and the steering angle maintains the straight steering state, the processor 40 determines that the vehicle is in the straight driving state vehicle, based on the lateral acceleration and yaw rate input from the input module 10.

For example, when the steering angle is 0±0.1[deg], the lateral acceleration is 0±0.01[g], and the yaw rate is 0±0.02[deg/s], the processor 40 may determine that the vehicle is in the straight driving state.

When the vehicle maintains the straight driving state in the straight steering state as described above, the processor 40 sets the current motor angle measured by the motor position sensor 20 as the absolute angle of zero point.

However, when the vehicle is not in the straight driving state in the straight steering state, the processor 40 performs slip angle feedback control based on the steering angle, the yaw rate, and the motor angle.

That is, the processor 40 calculates a front-wheel slip angle and a rear-wheel slip angle to set a target slip angle according to the current state of the vehicle such as vehicle speed, a steering angle, and road surface condition, and compares an actual slip angle with the target slip angle to compensate for the rear-wheel steering angle when a slip angle error occurs.

When the straight driving state is maintained by performing slip angle feedback control, the processor 40 sets the motor angle currently measured through the motor position sensor 20 as the absolute angle of zero point. In addition, processor 40 stops outputting warning when the warning is output through the output module 60.

As shown in FIG. 2, when it is difficult to confirm the absolute angle of zero point after the vehicle malfunctions or reset, the processor 40 outputs the response manual through the output module 60 to maintain the steering angle of zero degrees, and then performs feedback control so that the vehicle is in the straight driving state. In addition, when the setting conditions of the steering angle, lateral acceleration, and yaw rate are satisfied and the vehicle is determined to be in the straight driving state, the processor 40 sets the motor angle currently measured by the motor position sensor 20 as the absolute angle of zero point.

As described above, according to the rear wheel steering control apparatus of a vehicle according to the embodiment of the present disclosure, the driving states of the vehicle are collected through a motor position sensor without a linear position sensor in the rear wheel steering system to detect belt jumps, and even when there is a fault of the vehicle or reset, the absolute angle of zero point of the motor angle can be set without a linear position sensor. Therefore, according to the present disclosure, not only can the cost be reduced, but also the space for installing the linear position sensor can be secured, thereby increasing the degree of spatial freedom.

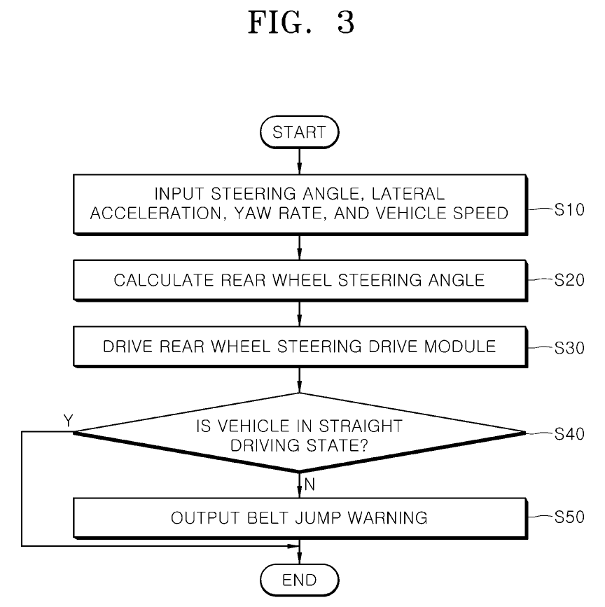

FIG. 3 is a flowchart illustrating a process of warning of a belt jump in a rear wheel steering control method of a vehicle according to an embodiment of the present disclosure.

Referring to FIG. 3 together with FIG. 1, in the process of warning of a belt jump in the rear wheel steering control method of a vehicle according to an embodiment of the present disclosure, first, the processor 40 executes an execution program stored in the memory 30 and then receives a steering angle, lateral acceleration, a yaw rate, and vehicle speed from in-vehicle control devices through the input module (S10).

After receiving the steering angle, the lateral acceleration, the yaw rate, and the vehicle speed in operation S10, the processor 40 calculates a rear wheel steering angle for rear wheel steering (S20).

After calculating the rear wheel steering angle in operation S20, the processor 40 drives the rear wheel steering drive module 50 based on the calculated rear wheel steering angle and a motor angle measured by the motor position sensor 20.

That is, the processor 40 steers the rear wheels based on the motor angle at which the rear wheel steering drive module 50 rotates the drive motor 55 and the rear wheel steering angle, thereby steering the rear wheels through the drive motor 55 (S30).

Thereafter, the processor 40 detects the occurrence of a belt jump by determine whether the rear wheel steering is operated normally in order to maintain the safety and performance of the rear wheel steering device while the vehicle is driving.

To this end, the processor 40 determines whether the vehicle is in a straight driving state based on the steering angle, the lateral acceleration, and the yaw rate input through the input module (S40).

In order to determine whether the vehicle is in the straight driving state in operation S40, the processor 40 determines whether the lateral acceleration is 0±0.01[g] and the yaw rate satisfies 0±0.02[deg/s] when the steering angle is 0±0.1[deg] based on the steering angle, the lateral acceleration, and the yaw rate.

In this way, when the straight driving state is satisfied by determining whether the vehicle is in the straight driving state in a the center alignment state in which the steering angle is zero , the processor 40 determines that a belt jump has not occurred and the vehicle is in a normal state.

However, when the straight driving state is not satisfied, the processor 40 determines that a belt jump has occurred and outputs a warning through the output module (S50).

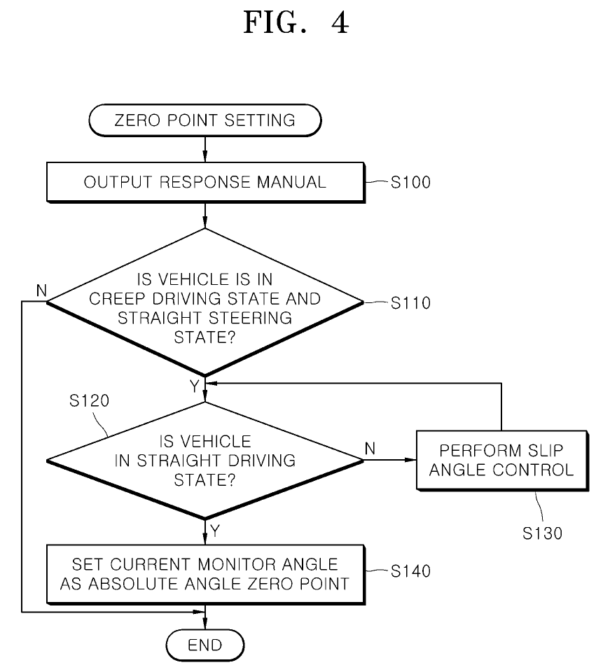

FIG. 4 is a flowchart illustrating a process of setting an absolute angle in a rear wheel steering control method of a vehicle according to an embodiment of the present disclosure.

Referring to FIG. 4 together with FIG. 1, in the process of setting the absolute angle of the rear wheel steering control method of a vehicle according to an embodiment of the present disclosure, when a belt jump occurs or reset occurs, the processor 40 outputs a response manual for setting the absolute angle of zero point through the output module 60 (S100).

After outputting the response manual in operation S100, the processor 40 determines whether the vehicle is in a creep driving state and a straight steering state, based on the vehicle speed and the steering angle (S110).

That is, the processor 40 determines whether the vehicle is creeping below a set speed and maintains the straight steering state with the steering angle of zero degree.

In this case, when the vehicle is in the creep driving state and straight steering state, the processor 40 determines whether the vehicle is in the straight driving state to set the absolute angle of zero point (S120).

For example, when the steering angle is 0±0.1[deg], the lateral acceleration is 0±0.01[g], and the yaw rate satisfies 0±0.02[deg/s], the processor 40 may determine that the vehicle is in the straight driving state.

In this way, when the vehicle maintains the straight driving state in the straight steering state, the processor 40 sets the current motor angle measured by the motor position sensor 20 as the absolute angle of zero point (S140).

On the other hand, when the vehicle is not in the straight driving state by determining whether the vehicle is in the straight driving state in operation S120, the processor 40 performs slip angle feedback control based on the steering angle, the yaw rate, and the motor angle (S130).

In this way, the processor 40 may perform the slip angle feedback control to compare an actual slip angle with a target slip angle and compensate for the rear wheel steering angle when a slip angle error occurs.

After performing the slip angle feedback control to compensate for the rear wheel steering angle, the processor 40 continues to determine whether the vehicle is in the straight driving state and sets the current motor angle measured by the motor position sensor 20 as the absolute angle of zero point when the straight driving condition is satisfied (S140).

As described above, according to the rear wheel steering control method of a vehicle according to an embodiment of the present disclosure, the driving states of the vehicle are collected based on a motor position sensor to detect belt jumps without a linear position sensor in a rear wheel steering system, and even when there is a fault or reset, the absolute angle of zero point of a motor angle can be set without the linear position sensor. Therefore, not only can cost be reduced, but also space for installing the linear position sensor can be secured, thereby increasing the degree of space freedom.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

What is claimed is:

1. A rear wheel steering control apparatus of a vehicle, comprising:
an input module configured to receive state information of the vehicle;
a rear wheel steering drive module configured to drive a drive motor according to a rear wheel steering angle to steer rear wheels of the vehicle;
a motor position sensor configured to measure a motor angle of the drive motor; and
a processor that is operatively coupled to the input module, the rear wheel steering drive module, and the motor position sensor,
wherein the processor is configured to drive the rear wheel steering drive module based on the rear wheel steering angle and the motor angle, and to determine whether the vehicle is in a straight driving state to output occurrence of a belt jump through an output module.

2. The rear wheel steering control apparatus of claim 1, wherein the processor is configured to determine that the vehicle is in the straight driving state when both lateral acceleration and yaw rate of the vehicle are within a set range in a straight steering state.

3. The rear wheel steering control apparatus of claim 2, wherein the processor is configured to determine the vehicle is in the straight driving state in the straight steering state to determine that the belt jump occurs when one or both of the lateral acceleration and the yaw rate are out of the set range and to output a warning.

4. The rear wheel steering control apparatus of claim 1, wherein when the belt jump or a reset occurs, the processor is configured to output a response manual through the output module, to determine that the vehicle is in a creep driving state and in a straight steering state based on vehicle speed and a steering angle, and to set the current motor angle as an absolute angle of zero point based on the straight driving state of the vehicle.

5. The rear wheel steering control apparatus of claim 4, wherein the processor is configured to determine whether the vehicle is in the straight driving state and to perform slip angle feedback control when the vehicle is not in the straight driving state.

6. A rear wheel steering control method of a vehicle, comprising:
driving, by a processor, a rear wheel steering drive module based on a rear wheel steering angle and a motor angle of a drive motor;
determining, by the processor, whether the vehicle is in a straight driving state; and
outputting, by the processor, a belt jump warning based on a result of determining whether the vehicle is in the straight driving state.

7. The rear wheel steering control method of claim 6, wherein in determining whether the vehicle is in the straight driving state, when both lateral acceleration and yaw rate of the vehicle are within set ranges in a straight steering state, the processor determines that the vehicle is in the straight driving state.

8. The rear wheel steering control method of claim 7, wherein in outputting the belt jump warning, when one or both of the lateral acceleration and the yaw rate are out of the set ranges as a result of determining whether the vehicle is in the straight driving state, the processor determines that a belt jump occurs.

9. The rear wheel steering control method of claim 6, further comprising:
outputting, by the processor, a response manual through an output module when the belt jump occurs or a reset occurs;
determining, by the processor, whether the vehicle is in a creep driving state and a straight steering state based on vehicle speed and a steering angle after outputting the response manual;
determining, by the processor, whether the vehicle is in the straight driving state after determining whether the vehicle is in the creep driving state and the straight steering state; and
setting, by the processor, a current motor angle as an absolute angle of zero point based on a result of determining whether the vehicle is in the straight driving state.

10. The rear wheel steering control method of claim 9, further comprising performing, by the processor, slip angle feedback control when the vehicle is not in the straight driving state as a result of determining whether the vehicle is in the straight driving state.
